(19) United States
(12) Patent Application Publication
(10) Pub. No.: US 2003/0089777 A1
(43) Pub. Date: May 15, 2003

(54) Method and system for authoring and playback of audio coincident with label detection

(76) Inventors: Ajit V. Rajasekharan, East Brunswick, NJ (US); Jonathan Travis Millman, New York, NY (US)

Correspondence Address: BROBECK, PHLEGER & HARRISON, LLP, ATTN: INTELLECTUAL PROPERTY DEPARTMENT, 1333 H STREET, N.W. SUITE 800, WASHINGTON, DC, 20005, US

(21) Appl. No.: 10/103,777

(22) Filed: Mar. 25, 2002

Related U.S. Application Data
(63) Continuation-in-part of application No. 09/987,587, filed on Nov. 15, 2001, now Pat. No. 6,513,971.

(51) Int. Cl. G06K 7/10; G06K 7/14

(52) U.S. Cl. 235/454

(57) ABSTRACT

The invention provides a labeling and content authoring scheme that enables seamless labeling, authoring, and playback of authored content, e.g., audio. In an embodiment of the invention, an apparatus comprises a scanner for acquiring an index value associated with a label, a microphone for recording audio from a user, a speaker for playing pre-recorded audio, and a processor for controlling the recording and playback of audio. The index value identifies an object and is implemented on the label using machine readable code. Memory storage stores the recorded audio for later playback. In operation, the index value is first read from the label. The processor then compares the read index value to one more index values stored in memory, wherein each stored index value is linked to one or more pre-recorded audio clips. If a match is not found between the read index value and any of the stored index values, the processor enters a record mode that enables the microphone to obtain audio, which is thereby stored in memory along with an association between the index value and the recorded audio. If a match is found, the processor enters a playback mode enabling playback via a speaker of the pre-recorded audio associated with the read index value.

### RELATED APPLICATION

The present invention is a continuation-in-part of U.S. patent application Ser. No. 09/987,587 filed on Nov. 15, 2001, which is hereby incorporated by reference in its entirety.

### BACKGROUND OF THE INVENTION

1. Field of Invention

The present invention relates to information management, and more particularly, to a method, system, and apparatus for recording or playing audio signals coincident with detecting labels associated with physical objects.

2. Description of Related Art

Labels are generally used as object identifiers to enable the association of relevant information with physical objects. For example, a slip of paper, sticker, or other material, marked or inscribed, is attached to an object to indicate its manufacturer, nature, ownership, destination, etc. Scanning devices used in a proactive fashion where a user scans an object of interest enable label information to be acquired from the object via a barcode, radio-frequency identification (“RFID”) tag, or infra-red (“IR”) tags. Generally, conventional devices directed toward associating audio information with physical objects typically focus solely on automatic playback of audio signals upon detection of a label. In particular, these devices provide information in audio format for objects that have already been labeled in a specific manner.

For example, U.S. Pat. No. 5,973,420 describes a method of using conductive compositions as a switching apparatus and as a replacement for conducting wires in circuits containing sound chips. The entire circuit including power source and speakers is embedded on objects desired to be annotated with audio. One drawback of this scheme is the need to embed an entire playback apparatus including power source to each labeled object. Therefore, custom labeling, e.g., custom authoring and playback of information to be bound to the label, is not possible because the labeling process involves embedding the entire circuitry on the object of interest.

U.S. Pat. No. 5,877,458 describes an electrographic sensor unit and method for determining the position of a user selected position thereon. The electrographic sensor unit includes a layer of a conductive material having an electrical resistance and a surface with spaced apart contacts to selectively apply a signal to each of the contact points. This apparatus determines a surface location touched by a user using either a probe assembly or finger and triggers playback of audio that is pre-authored for that location. One drawback of this scheme is the tight constraint imposed by the coordinate determination scheme on the objects that can be labeled. For example, the invention does not permit labeling and annotating of different physical objects because the authored content is tightly bound to the different coordinates on the surface of a single object as opposed to content on different objects. Even within a single object, since binding is done to coordinates, additional cues are required by the system to determine the context of the coordinate. For example, if a book is annotated using this invention, additional page cues are required to resolve the ambiguity of the coordinates since all pages return the same coordinates for a particular contact locus. This deficiency is further apparent when there is a need to author content for different physical objects. Even though the sensor unit can be embedded on complex three-dimensional surfaces, it requires that each of the objects have the location determination scheme within them. A single location sensing device cannot be used to annotate objects of disparate dimensions and shapes.

U.S. Pat. No. 5,896,403 describes a printing process system where the authored content is embedded on a label during printing. This is used in conjunction with a device that can read the data of these labels and render the authored content. One drawback of this system is the complexity of the authoring process, particularly the complexity of the required printing system. Another drawback is the inherent inflexibility of re-authoring content for a label. For example, each printed label has embedded authored data that cannot be changed or modified. Therefore, re-authoring, i.e., associating new or different data to an object already having an existing printed label, requires creating a new label using the printing process. Embedded data poses a physical constraint on the label size, e.g., the larger the data to be authored the greater the size of the label.

U.S. Pat. No. 3,782,734 discloses embedded authored data in the form of special grooves on a surface to be annotated. Particularly, this process requires moving a transducer through a groove at a rate approximating the recording speed, wherein the groove length has a direct relationship to the amount of audio being authored. A drawback of this technique is the inability to do custom authoring since content creation involves the complicated process of embedding special grooves containing the content. Moreover, the possibility of implementing this technique on planar object surfaces, such as pages of a book, is minimal if not entirely nonexistent because of the feasibility of incorporating special grooves.

U.S. Pat. No. 4,375,058 discloses embedded authored content with synchronization information in coded form on a label. A synthesizer resident on a sensing device generates the authored audio during playback. This type of scheme suffers from at the least drawbacks mentioned in U.S. Pat. No. 3,782,734 and U.S. Pat. No. 5,896,403.

U.S. Pat. No. 5,480,306 describes a language learning apparatus wherein a predetermined mapping is established between optical codes/barcodes and words, sentences, pictures. When an optical code/barcode is read by an appropriate device, a lookup step is performed to find a predetermined mapping between the code read and the sound associated with that code. One disadvantage of this scheme is that a user is burdened with the responsibility of manually maintaining the association between label data and authored content. This manual process is error prone at two stages in the authoring phase. For example, during the physical labeling of objects, a user may stick the label on the wrong object. Moreover, during the authoring of content, a user has to maintain the correspondence between the label code and the authored data. Therefore, there is a possibility of mismatch between label code and authored data.

U.S. Pat. No. 5,314,336 describes a toy capable of recognizing marks on objects placed in front of it and accordingly, articulating words or phrases in response to the markings. Electronic representations of the various sounds may be stored in the toy or on a removable media so that the variety of sounds may be changed as desired. This apparatus suffers from the same drawbacks as some of the above-noted patents, in particular, cumbersome content authoring and the possibility of mismatch between label code and authored data.

U.S. Pat. No. 6,089,943 describes a soft toy carrying a barcode scanner for scanning a number of barcodes each individually associated with a visual message in a book. One disadvantage of this apparatus is that there is no means for custom labeling of objects and custom content authoring for those objects.

### SUMMARY OF THE INVENTION

The present invention overcomes these and other deficiencies of the related art by providing a labeling detection and recording/playback scheme that enables label detection coincident with the recording and playback of authored content, e.g., audio.

In an embodiment of the invention, a portable, hand-held device comprises a scanner for acquiring an index value associated with a label, a microphone for recording audio from a user; a speaker for playing pre-recorded audio, and a processor for controlling the recording and playback of the audio. The index value identifies the object and is implemented on the label using machine readable code. Memory storage is included to store recorded audio for later playback. In operation, the index value is first read from the label and is then compared to one or more index values stored in memory, wherein each stored index value is linked to one or more audio clips. If a match is not found, the processor enters a record mode that enables the audio to be recorded and bound to the index value. If a match is found, the processor enters a playback mode that enables playback via the speaker of pre-recorded audio associated with the read index value.

In another embodiment of the invention, a pen-like device comprises a scanner for generating a scanner signal to acquire an index value from a label, a depressible portion having a scanner signal pathway traversing the depressible portion, which depressed initiates the scanner to generate the scanner signal. The device further comprises a microphone for acquiring audio, a speaker for playing pre-recorded audio, and a processor for processing the index value and audio in a similar fashion to the embodiment described above. In operation, the depressible portion of the device is pressed and held against a label to initiate a scan.

In another embodiment of the invention, a method comprises the steps of scanning a label to acquire an index value, determining whether or not the index value matches a stored index value, and alternatively either binding recorded audio to the acquired index value if no match is determined or playing pre-recorded audio bound to the acquired index value if a match is determined.

In another embodiment of the invention, a system comprises one or more labels, and a device comprising a label scanner for acquiring an index value from a label, a microphone, a speaker, memory for storing one or more audio clips and one or more index values, and a processor for processing the index value. The processor enables recording of audio via the microphone to memory and associates this recorded audio to the index value. In a playback mode, the processor enables playback of pre-recorded audio associated with the index value through the speaker.

An advantage of the invention is that it allows automatic playback of authored content upon detection of a label. Another advantage is that it enables custom labeling of objects and content authoring for those objects.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates an audio authoring/playback label detection system according to an embodiment of the invention;

FIG. 2A and FIG. 2B illustrate a “reading wand” authoring/playback label detection system according to an embodiment of the invention;

FIG. 2C illustrates a particular embodiment of the reading wand system illustrated in FIG. 2A and FIG. 2B;

FIG. 3 illustrates an audio authoring/playback coincident with label detection method according to an embodiment of the invention;

FIG. 4 illustrates a label binding system according to an embodiment of the invention;

FIG. 5 illustrates a deletion method according to an embodiment of the invention;

FIG. 6 illustrates a label according to an embodiment of the invention; and

FIG. 7 illustrates a distributed network system according to an embodiment of the invention.

### DETAILED DESCRIPTION OF THE PREFERRED EMBODIMENTS

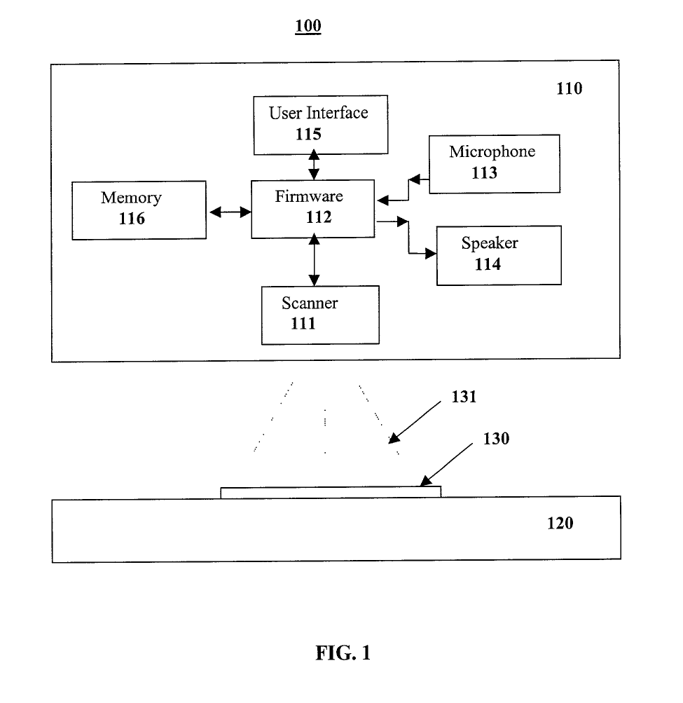

Preferred embodiments of the present invention and their advantages may be understood by referring to FIGS. 1-7, wherein like reference numerals refer to like elements, and are described in the context of a system, method, and apparatus for binding labels with authored information. Particularly, the preferred embodiments are described in the context of label detection coincident with authoring and playback of content, such as audio. Nevertheless, the inventive concept can associate label detection with other content types, such as, but not limited to, data, video, images, text, or a combination thereof.

Referring to FIG. 1, a labeling system 100 comprises an audio recording/playback device 110, an object 120, and a label 130. Label 130 is affixed to object 120 by conventional means, such as adhesive, implementation of which is apparent to one of ordinary skill in the art. Alternatively, label 130 can be imprinted on or embedded into object 120. Although only one object and label is depicted, system 100 can comprise a plurality of objects and labels, with one or more labels affixed to each object. Label 130 comprises machine readable information (not shown) to be interpreted by device 110. This machine readable information comprises an index value or other identification data to identify the object, and optional validation and/or authentication information to validate and/or authenticate the label. Preferably, label 130 is a sticker-like material wherein the machine readable information is in the form of optical symbols that can be read optically, such as in the visual light region or non-visual light region, e.g., infrared or ultraviolet. In alternative embodiments, label 130 implements an alternative conventional labeling technology, such as, for example, a radio-frequency identification (“RFID”) device wherein the machine readable information is electronically stored.

Audio recording/playback device 110 comprises a scanner 111, firmware 112, a microphone 113, a speaker 114, a user interface 115, and memory 116. Scanner 111 is preferably an optical scanner, however alternative types of scanners may be implemented to facilitate alternative label schemes, e.g., RFID. Firmware 112 is a processor to enable device operations, which the following discusses in detail. The term processor denotes any logic, circuitry, code, software, and the like that is configured to perform the functions described herein. In addition to controlling various input and output components, firmware 112 facilitates the response of device 110 to various inputs via user interface 115. For example, user interface 115 comprises one or more input and/or output devices (not shown), such as, but not limited to, input keys or buttons, a display (not shown), voice recognition logic, or a combination thereof to assist user interaction with device 110. Memory 116 comprises internal memory, such as digital random access memory (“RAM”) based storage or the like, magnetic storage, or any other permanent type memory to store data. In alternative embodiments, internal memory is supplemented by or replaced with a removable storage device, such as, but not limited to, flash memory, zip storage, or optical storage.

In operation, the machine readable information on label 120 is acquired by scanner 111 via signal 131, which is then processed by firmware 112. Firmware logic determines an appropriate action to be performed, such as authoring, i.e., recording, of audio using microphone 113 in a record mode or playback of authored audio using speaker 114 in a playback mode. Authored audio is stored in memory 116 for subsequent retrieval and playback. During operation, a user controls device 110 by interacting with firmware 112 via user-interface 115.

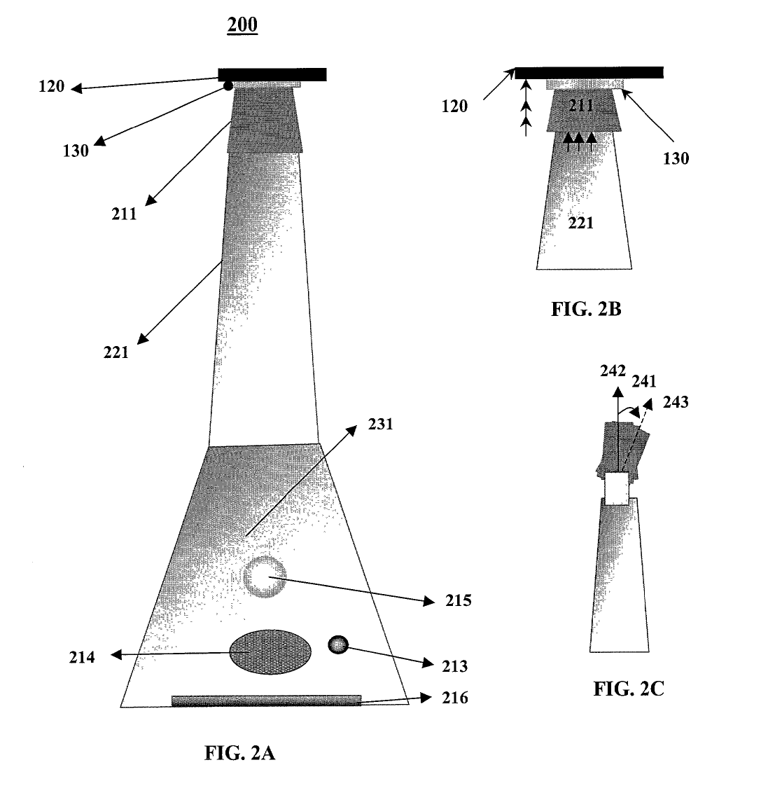

FIG. 2A illustrates a labeling system 200 comprising an ergonomically designed hand-held “reading wand” 210 for use as a comfortable, simple, and efficient audio recording/playback device. In this particular embodiment, reading wand 210 features a pen-like shape comprising a tip 211, a shaft 221, and a base 231. Shaft 221 can be cylindrically shaped with or without the gradient shown. Wand 210 further comprises a microphone 213, a speaker 214, and a user interface 215, which are all preferably located in base 231 to minimize the volume of shaft 221 so that a human, particularly a child, can easily grip the device. Reading wand 210 also comprises firmware (not shown) and optional internal memory (not shown). User interface 215 is shown as a single button, which may control one or more particular operation of reading wand 210. For example, this button may be used to stop playback of audio. However, user interface 215 can comprise plural buttons (not shown) on one or more sides of base 231, each button controlling a particular operation of reading wand 210, such as, for example, deleting audio in memory, locking the device to prevent accidental recording and/or deletion, controlling volume, etc. Base 231 is preferably wider than tip 211 and shaft 221 as shown to provide ample space for microphone 213, speaker 214, user interface 215, an optional storage card slot 216 for removable storage mediums, scanner electronics, and a power supply or adapter (not shown).

Label scanning, illustrated in FIG. 2B, is initiated by pressing and holding tip 211 against label 130 associated with object 120. Particularly, depressing tip 211 activates a scanner (not shown) to acquire information from label 130 by means of a scanner signal pathway traversing tip 211. An optional audio signal, e.g., beep or pre-recorded cue, or display light can notify a user when an adequate scan is completed and/or when an error has occurred. In the embodiment of the invention shown in FIG. 2C, tip 211 can have a degree of rotational freedom 241 to accommodate different angles subtended by an axis 242 of reading wand 210 and a vector 243 normal to the surface of label 130.

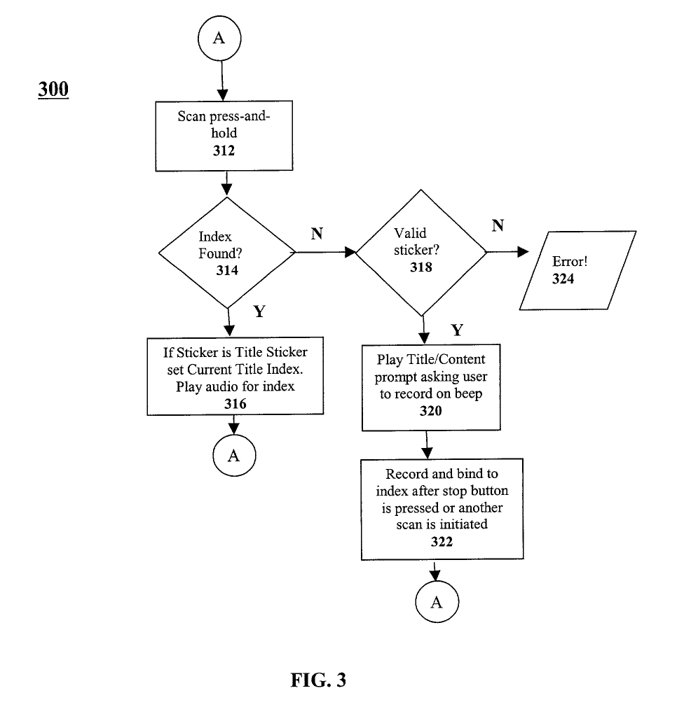

Referring to FIG. 3, a method 300 for content authoring or playback is illustrated. An index value is first obtained from the label by scanning the label. In the reading wand embodiment, the index value is acquired by the press-and-hold (step 312) of device tip 211 over a label 130. A check (step 314) is then performed to determine if the acquired index value matches any of one or more index values stored in memory. If an index value stored in memory is found to match the acquired index value from the label, audio associated with that index is retrieved from memory and played (step 316) through speaker 214. In an embodiment of the invention, retrieved audio is stored in a compressed format and subsequently decompressed prior to rendering through a speaker. If the index value obtained from the label does not match any of those stored and the label is identified as a valid label (step 318), a user is prompted (step 320) by an optional pre-recorded audio prompt to record (step 322) audio after an optional audio cue. If the label is found to be an invalid label, the user is notified (step 324) via an error signal.

In an embodiment of the invention, label validity depends on whether the scanner is able to fully read a portion of the data contained within the label. For example, a checksum comparison is performed between a checksum read directly from the label and a checksum computed from a portion of data scanned from the label. A label is deemed to be invalid if the checksum comparison fails, i.e., the two checksums differ. In another embodiment of the invention, authentication data is included in the information contained within the label. For example, an appropriate authentication scheme, implementation of which is apparent to one of ordinary skill in the art, is employed to authenticate the label. Such authentication denotes the label manufacturer and potentially prevents unauthorized production of labels.

Audio may be recorded and stored in conventional formats, which are apparent to and can be implemented by one of ordinary skill in the art. For example, audio can be recorded and stored in digital file formats such as, but not limited to, Motion Pictures Expert Group (“MPEG”) audio layer 3 (“MP3”) and waveform sound format (“WAV”). One or more compression algorithms, such as, but not limited to, algebraic code excited linear prediction (“ACELP”) based algorithms, adaptive differential pulse code modulation (“ADPCM”), and MuLaw algorithm, are optionally implemented prior to storing audio in memory. Recording can be terminated by a user either by pressing a STOP button or by initiating another scan. At this point, the recorded audio is bound to the scanned index value associated with label 130.

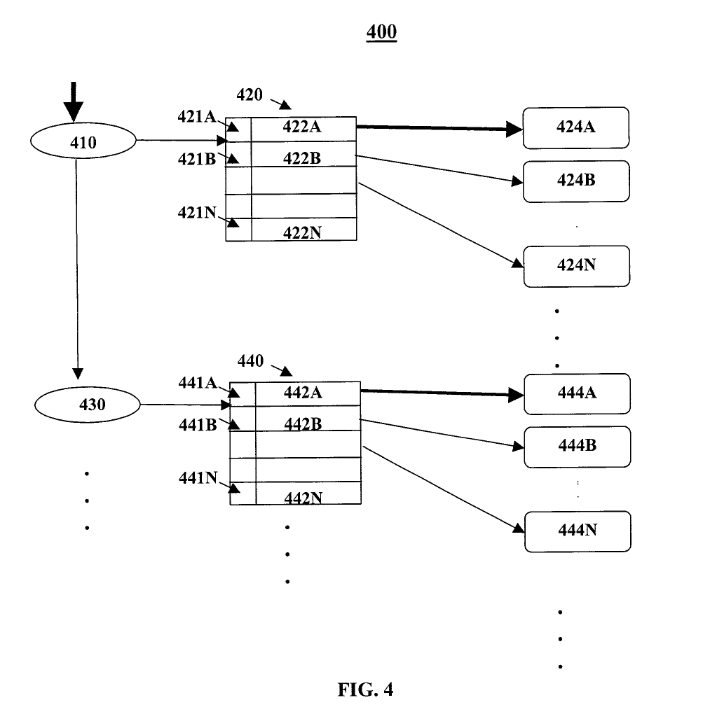

FIG. 4 illustrates an audio binder hierarchical system 400 for logically aggregating a plurality of audio clips to one or more labels. In this embodiment of the invention, a binder node 410 combines label index values 421A-N, where N is at least one, into an index table 420. Index table 420 associates label index values 421A-N with audio clips 424A-N by using pointers 422A-N, thereby forming a logical hierarchy of multiple labels and audio content for a node. Pointers 422A-N comprise information pertaining to, for example, a storage location or HTTP link, thereby correlating each index value with one or more respective stored audio clips. One or more binder nodes, for example, binder nodes 410 and 430 as shown, form a top level of the hierarchical tree. Binder nodes 410 and 430 point to index tables 420 and 440, respectively, each comprising respective label index values 421A-N and 441A-N, and pointers 422A-N and 442A-N facilitating the retrieval and storage of audio clips 424A-N and 444A-N associated those index values. Logical binding facilitates memory management such as one-step deletion of all labels that are logically related. The hierarchical structure also enables quick navigation between binder nodes each representing, for example, authored audio for separate books, chapters in a book, or any object that is suitable for the aggregation of a group of labels and/or audio clips.

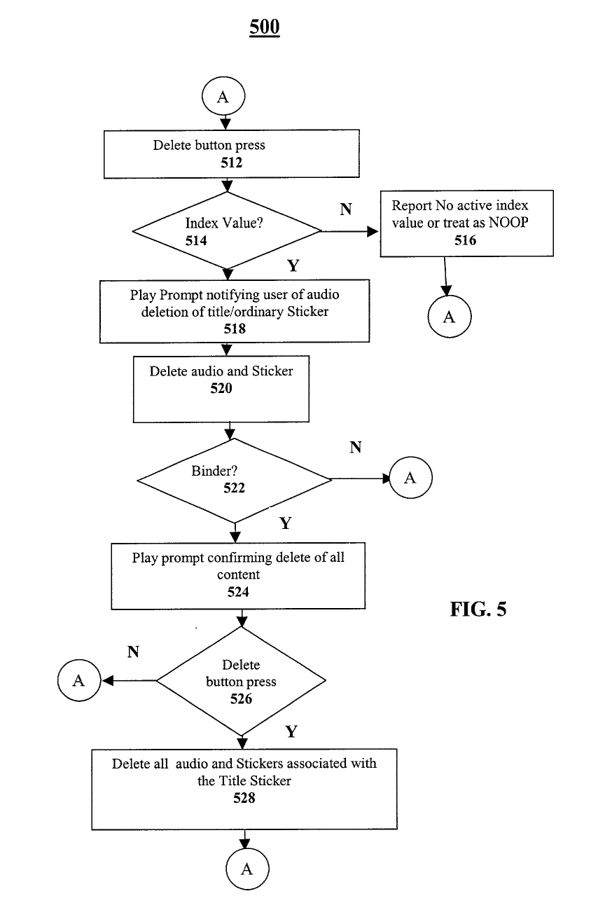

Referring to FIG. 5, audio deletion process 500 is illustrated according to an embodiment of the invention. Audio deletion process 500 facilitates efficient memory housekeeping, particularly, the deletion of audio associated with a label either for reclaiming memory space or as part of re-authoring audio for that label. Re-authoring of audio for a label is accomplished by first deleting audio for that label and then authoring audio for that label or alternatively, writing new audio to storage directly over old audio. The delete operation is initiated by a user pressing (step 512) an appropriate button, such as a delete button, on the device. The device determines (step 514) if the current index value corresponds to a valid label. Optionally, the index value of any valid label remains the current active index until another valid label is scanned or a delete operation is completed. The delete action is ignored (step 516) if the current index value does not correspond to a valid label and subsequently, either reported to the user or treated as a no operation (“NOOP”) command by the device. If the current index value corresponds to a valid label, a pre-recorded audio prompt is played (step 518) notifying a user that an audio deletion is being or about to be performed. After deletion the audio clip associated with that index value (step 520), a check is performed (step 522) to see if the deleted index value is associated with a binder. Accordingly, the user is prompted (step 524) with a pre-recorded audio prompt to confirm deletion of all audio associated with that binder. If the user confirms by pressing (step 526) an appropriate button, all audio associated with that binder is deleted (step 528).

In an embodiment of the invention, an omni-directional, angle independent labeling scheme is employed to enable efficient and contact locus independent label detection. Preferably, code symbols, such as, DataMatrix barcode (ECC 200) symbols are used. These symbols can be printed invisibly using near infra-red ink on colored backgrounds to form aesthetically pleasing labels. Nevertheless, less aesthetically labels can be utilized using visible ink and/or non-colored labels. DataMatrix symbology enables omni-directional, angle independent scanning of labels with a very high degree of error correction capability.

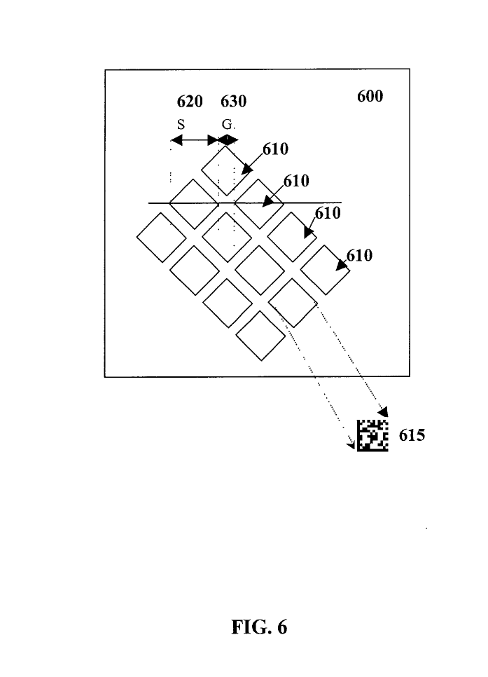

In a preferred embodiment of the invention as illustrated in FIG. 6, label 600 comprises one or more code areas 610 tiled over a portion of the label. Each code area 610 comprises data matrix 615 encoding an index value, an optional checksum, and optional validation and authentication information. A plurality of code areas 610 enable label detection anywhere on the label instead of just one position on the label. The size of the code area is preferably chosen to take into account the aperture size of the device scanner. Preferably, an engineering balance is struck between the tiling density and the code size to enable quick scanning with a high degree of error correction. In addition to facilitating label detection when the scan head is placed anywhere on or near the label, the tiling scheme also provides error recovery augmenting the error correction capability of the DataMatrix symbology by duplication of the codes. DataMatrix symbology enables a large amount of numeric data to be embedded on a small size label. For example, a 14×14 module matrix encoding sixteen (16) decimal numeric digits can be made into a square area having an edge as small as 1.78 mm in length. This encoded decimal value is equivalent to 53 bits of binary storage. This large number space is divided into separate spaces for distinguishing between different types of labels, such as, individual labels, binders, and special purpose stickers. In alternative embodiments, barcodes or other conventional coding schemes are used in place of or in addition to the DataMatrix symbology. For example, code areas on a single label can implement different types of coding schemes, thereby enabling different scanning devices to each read the same label.

In an embodiment of the invention, tiling density is tuned to guarantee that at least one code area 610, falls within an aperture size of a scanner tip or head, or the range or beam width of a scanner signal. For example, an aperture size, D, of a scanner tip given by

D=(S+G)*(N+1),

wherein S is a diagonal length 620 of code area 610, G is a quiet zone width 630, and N is the number of code areas, generally guarantees that at least N code areas are within the range of the aperture. By choosing an aperture size D according to the above formula, with N greater than 1, code duplication provides a safeguard against label damage caused by smudging, scratching, and fading. For labels with irregular boundaries, a visually aesthetic cue for contact locus can be provided on the label.

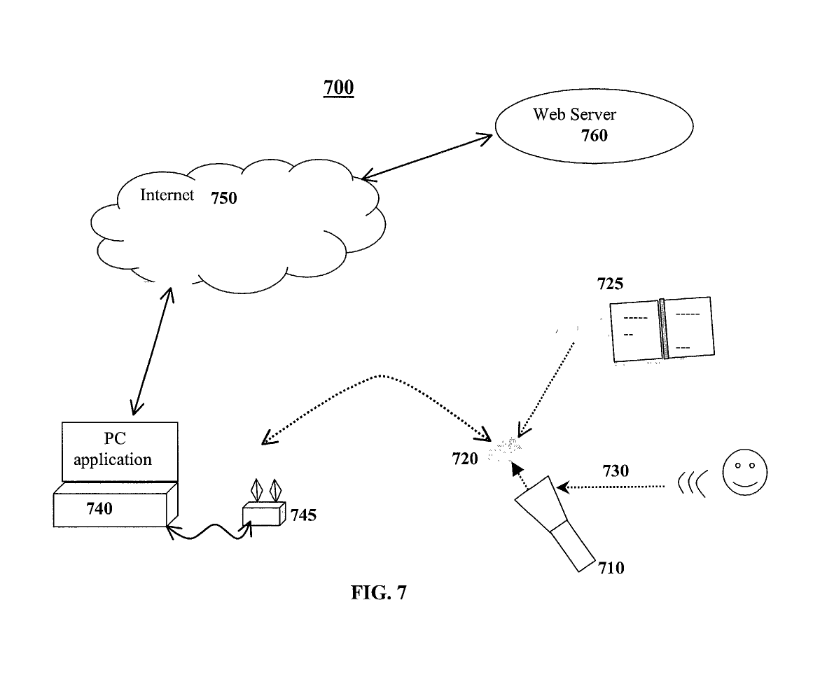

Audio production and distribution options are fairly diverse enabling a wide variety of usage of the inventive concept. For example, FIG. 7 illustrates a distributed system 700 according to an embodiment of the invention for implementing authoring/plackback device 710 in a distributed network environment. Authored audio can be stored on a storage card 720 and accessed by user 730 during authoring or playback. Additionally, pre-authored audio for a book 725 is optionally distributed on storage card 720 for usage on device 710. Audio can also be optionally downloaded to a host computer 740 and written to storage card 720 via a storage card writer 745. Downloaded audio at computer 740 can originate from a web server 760 accessed through a network 750, such as, the internet, or directly authored using a client application installed on computer 740. Moreover, a user can upload recorded audio content to web server 760 via network 750.

The inventive concept is applicable to a wide range of usage scenarios, such as, but not limited to, custom labeling, template and grid labeling, and embedded labeling scenarios. In a custom labeling scenario, labels in the form of individual stickers are placed on objects, such as physical items or books, by a user. Audio is then authored and bound to the label. This type of scenario is ideal for parent authoring audio for children's books, album annotations, object cataloging, home reading, and creating custom home games such as a treasure hunt. In a template and grid labeling scenario, label stickers are manufactured as, for example, translucent templates for popular books where a user sticks the template pages as an overlay over one or more pages of the book. This type of usage is ideal for activity books, rhyme books, picture books, etc. Audio storage cards for these templates can be packaged along with the templates. Parents can do custom authoring even in this case, thereby overriding existing authored audio. Generic translucent tiled grids for standard book sizes can also be created to enable authoring of audio for any location in the book without the need to stick individual labels. In these generic tiled grids, the same code can be duplicated for a small region of the grid to obviate the need for accurate repositioning for audio retrieval. These generic grids can be overlaid on pages of a book enabling any position on the book to be annotated, which is particularly useful for language learning where each word or sentence could be annotated with spelling, pronunciation, and phonetic sounds. In an embedded labeling scenario, objects such as books are printed with embedded labels on them and are sold along with storage cards containing the audio for those labels. This type of usage is ideal for books and three dimensional models, such as a globe or human anatomy model. Distribution of pre-authored audio with embedded or generic grid labels is an attractive combination since it would enable custom authoring of the book, thereby augmenting the pre-authored audio without overriding the pre-authored audio.

Advanced authoring can involve creating audio for labels in the form of special purpose stickers with conditional and modal semantics. Stickers with conditional semantics enable audio associated with a sticker to be triggered contingent upon the current sticker scan and a preceding scan of another particular sticker. Modal stickers are useful in scenarios such as language learning books where the scanning of a label would trigger the pronunciation, spelling, or phonetic elements of a word if the device mode was set to the appropriate state. The mode setting is done by the use of special modal stickers or by additional hardware button interfaces. In addition to playback of audio associated with modal and conditional stickers authoring of audio for these stickers can be accomplished on the device by the use of additional hardware buttons or by the use of special authoring support stickers. Playback of these stickers would be accomplished by the firmware that contains the semantics to handle special purpose stickers. To account for the possibility of enhancing semantics of stickers, device may support device firmware upgrade using the storage card as the facilitator for device firmware upgrade.

Other embodiments and uses of the invention will be apparent to those skilled in the art from consideration of the specification and practice of the invention disclosed herein. All references cited herein, including all U.S. patents, are hereby incorporated herein by reference in their entirety. Although the invention has been particularly shown and described with reference to several preferred embodiments thereof, it will be understood by those skilled in the art that various changes in form and details may be made therein without departing from the spirit and scope of the invention as defined in the appended claims.

We claim:

1. An apparatus comprising:
a scanner for acquiring first data associated with a label;
an input for acquiring second data; and
a processor for processing data and creating binding data binding said first data to said second data.

2. The apparatus of claim 1, wherein said first data comprises an index value identifying said label.

3. The apparatus of claim 1, wherein said scanner is an optical code scanner.

4. The apparatus of claim 1, wherein said input is a microphone and said second data is audio.

5. The apparatus of claim 1, wherein said input is removable storage memory and said second data is audio stored in said removable storage memory.

6. The apparatus of claim 1, wherein said input is a receiver for receiving said second data from a remote location.

7. The apparatus of claim 1, wherein said binding data comprises said first data and link data linking said first data to said second data.

8. The apparatus of claim 1, further comprising
an output for outputting said second data.

9. The apparatus of claim 8, wherein said output is a speaker and said second data is audio.

10. The apparatus of claim 1, further comprising
storage memory,
wherein said input is a microphone and said second information is audio, said first data comprises an index value, said processor in a record mode generating said binding data and enabling said audio to be recorded to said storage memory, said binding data comprises said index value and a storage location of said recorded audio.

11. The apparatus of claim 10, wherein said record mode is initiated upon said processor processing said index value and not finding a matching index value stored in said storage memory.

12. The apparatus of claim 1, further comprising
a speaker, and
storage memory,
wherein said first data comprises a first index value, said storage memory comprises pre-recorded audio and a second index value, said second index value bound to said pre-recorded audio, said processor in a playback mode enabling playback of said pre-recorded audio via said speaker.

13. The apparatus of claim 12, wherein said playback mode is initiated upon said processor processing said first index value and determining that said first and second index values are equal.

14. The apparatus of claim 1, further comprising
a speaker,
a storage memory,
wherein said input is a microphone and said second information is audio, said first data comprises an index value,
said processor in a record mode generating and storing said binding data to said storage memory and enabling said audio to be recorded to said storage memory,
said processor in a playback mode enabling playback via said speaker of pre-recorded audio bound to said index value.

15. The apparatus of claim 1, wherein said apparatus is portable.

16. The apparatus of claim 15, wherein said apparatus is a hand-held device.

17. The apparatus of claim 16, further comprising
a depressible portion comprising
a scanner signal pathway traversing said depressible portion, said depressible portion initiating said scanner to generate a scanner signal when said depressible portion is depressed.

18. An apparatus comprising:
a scanner for acquiring first data from a label;
a depressible portion, wherein said depressible portion comprises a scanner signal pathway traversing said depressible portion, said depressible portion initiating said scanner to generate a scanner signal when said depressible portion is depressed;
memory storage;
an input for acquiring second data;
an output for outputting third data; and
a processor for processing data, wherein said processor in an input mode enables acquisition said second data, and said processor in an output mode enables output of said third data.

19. The apparatus of claim 18, further comprising a base portion, wherein said base portion comprises said input, said output, and said processor.

20. The apparatus of claim 19, further comprising a connecting portion connecting said base portion to said depressible portion.

21. The apparatus of claim 20, wherein said connecting portion is configured for gripping by a human hand.

22. The apparatus of claim 21, wherein said depressible portion has a degree of rotational freedom about said connecting portion.

23. The apparatus of claim 18, wherein said input is a microphone and said second data is audio, said processor in said input mode further enabling said audio to be stored to said storage memory.

24. The apparatus of claim 18, wherein said storage memory comprises said third data, said output is a speaker and said third data is audio, said processor entering said output mode upon processing said first data and enabling retrieval of said third data from said memory storage.

25. The apparatus of claim 18, wherein said memory storage is removable storage.

26. The apparatus of claim 18, further comprising a modem for downloading or uploading said second data from or to a remote location.

27. The apparatus of claim 18, wherein said apparatus is portable.

28. A method comprising the steps of:
scanning a label to acquire an index value;
determining whether or not said acquired index value matches a stored index value; and alternatively
acquiring first data and storing said index value and said first data, if no match is determined; or
outputting second data, if a match is determined.

29. The method of claim 28, wherein said first and second data are audio.

30. The method of claim 28, wherein said second data comprises a portion of said first data.

31. The method of claim 28, wherein said step of acquiring comprises
recording said first data via a microphone, wherein said first data is audio.

32. The method of claim 28, wherein said step of outputting comprises
playing said second data via a speaker, wherein said second data is pre-recorded audio.

33. The method of claim 28, wherein said scanning step comprises the step of
generating a scanner signal upon depressing a depressible portion depressed against said label.

34. The method of claim 28, further comprising the step of
validating said label.

35. The method of claim 28, further comprising the step of
authenticating said label.

36. A method comprising the steps of:
acquiring first data from a label;
acquiring second data from an input; and
creating third data binding said first data to said second data, wherein said third data comprises said first data.

37. The method of claim 36, further comprising the step of
storing said second and third data in a storage medium.

38. The method of claim 37, wherein said second data is audio and said input is a microphone.

39. The method of claim 36, further comprising the step of
outputting said second data via an output.

40. The method of claim 39, wherein said second data is audio, and said output is a speaker.

41. The method of claim 36, wherein said first data comprises an index value, a checksum, and authentication data.

42. The method of claim 41, further comprising the step of
validating said label using said checksum.

43. The method of claim 41, further comprising the step of
authenticating said label using said authentication data.

44. The method of claim 36, wherein said step of acquiring first data comprises
scanning said label with a scanner.

45. The method of claim 44, wherein said scanner is an optical scanner.

46. A system comprising:
one or more labels; and
a device, wherein said device comprises:
a label scanner for acquiring an index value from a label,
a microphone,
a speaker,
memory for storing one or more audio clips and one or more index values, and
a processor for processing said index value, wherein said processor in a record mode enables recording of audio via said microphone to said memory and associated said audio to said index value, and said processor in a playback mode enabling playback via said speaker of audio associated with said index value.

47. The system of claim 46, wherein a portion of said one or more labels are associated a number of objects.

48. The system of claim 47, wherein said number is one, said object is a book.

49. The system of claim 46, wherein a portion of said one or more labels are embedded into an object.

50. The system of claim 46, wherein said labels are stickers.

51. The system of claim 50, wherein said stickers comprise invisible code, said scanner acquiring said index value from said invisible code.

52. The system of claim 46, said memory comprising a logical aggregation of one or more audio clips associated with said one or more labels.

53. The system of claim 46, wherein said one or more labels each comprise one or more code areas, wherein each code area represents said index value.

54. The system of claim 53, wherein said one or more code areas are tiled on said label.

55. The system of claim 54, wherein said index value is represented by a DataMatrix code.
